(19) United States
(12) Patent Application Publication
(10) Pub. No.: US 2016/0308875 A1
(43) Pub. Date: Oct. 20, 2016

(54) INTERNET SECURITY AND MANAGEMENT DEVICE

(71) Applicant: Lantern Security, LLC, Atlanta, GA (US)

(72) Inventors: Paul Qantas Judge, Atlanta, GA (US); Michael Van Bruinisse, Marietta, GA (US); Daniel Jack Peck, Decatur, GA (US); Paul Harris Royal, Atlanta, GA (US)

(21) Appl. No.: 15/133,269

(22) Filed: Apr. 20, 2016

Related U.S. Application Data
(60) Provisional application No. 62/149,990, filed on Apr. 20, 2015.

(51) Int. Cl. H04L 29/06

(52) U.S. Cl. CPC H04L 63/102; H04L 63/20

(57) ABSTRACT

Systems and methods to secure and manage home or other networks. A security management device is connected to the home network that learns about the people and devices who use the network to keep them safe and secure. The security management device determines what devices are on the network, what they are doing, and if visitors or unknown devices are attempting to gain access to the network. The security management device provides for content filtering using, e.g., a slider, to set a maturity level such as G, PG, PG-13 and None. The security management device enforces filtering polices across all devices, websites, and apps. In some implementations, the content filter is enforced on devices, such as smartphones and other handheld devices that are used off the network outside the home. The security management device may also enforce quiet hours, where Internet access is shut-off after a certain time.

### CROSS-REFERENCE TO RELATED APPLICATION

This application claims priority to U.S. Provisional Patent Application No. 62/149,990, filed Apr. 20, 2015, entitled “INTERNET SECURITY AND MANAGEMENT DEVICE,” which is incorporated herein by reference in its entirety.

### BACKGROUND

In the growing, hyper-connected world of the “Internet of Things” (IoT) more-and-more devices are being deployed into home networks. The Internet of Things (IoT) often refers to common household devices that are now being connected to the Internet. Examples include smart electric meters, in-home thermostats, alarm systems, entry locks, garage door openers and refrigerators that send alerts when the milk runs out. All of these devices introduce vulnerabilities and many home users do not have the technical capabilities to secure their networks, because, configuring firewalls, setting policies and updating devices is difficult and time consuming.

In addition, children are now exposed to the Internet at an early age using a multitude of devices, such as traditional notebook and desktop computers, hand-held gaming devices, gaming consoles, smartphones, and the like. Limited options exist to control Internet access on such consumer devices, as the options are typically device-specific leaving unsupported devices open for use or abuse.

### SUMMARY

Disclosed herein are systems and methods managing network access. An example method includes receiving a Domain Name Service (DNS) request from a device on a network, the device being associated with a user and the request being in the form of a Uniform Resource Locator (URL); determining an identity of the device or user making the DNS request; retrieving a policy associated with the device or user; applying the policy to the DNS request; and returning a response to the DNS request that is either an IP address associated with the URL or a IP address of a block page that is defined by the policy.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example environment in which the present disclosure may be implemented;

FIG. 2 illustrates an example operational flow for configuring a security management device for use on a network;

FIG. 3 illustrates an example operational flow for discovers devices on the network;

FIG. 4 illustrates an example operation flow to associate users to devices on the network;

FIG. 5 illustrates an example operational flow of the security management device operating as a DNS server for the network;

FIGS. 6-11 illustrate example user interfaces associated with the operational flow of FIG. 2;

FIGS. 12-18 illustrate example user interfaces associated with the operational flow of FIG. 3;

FIGS. 19-20 illustrate example user interfaces associated with the operational flow of FIG. 4;

FIGS. 21-22 illustrate example reports as of dashboards, snapshots of user's website visits or other usable interfaces;

FIGS. 23-25 illustrate example reports of statistics related to content filtering, security monitoring and network performance;

FIGS. 26-27 illustrate example reports of a specific user's activity;

FIG. 28 illustrates an example user interface to provide an administrator with an option to edit polices;

FIG. 29 illustrates an example user interface to provide an administrator with alerts and an options to override a request; and

FIG. 30 shows an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for providing a highly scalable, fault tolerant remote access architecture and methods for connecting clients to remotely accessed applications and services provided by the remote access architecture, it will become evident to those skilled in the art that the implementations are not limited thereto.

Overview

The subject matter of the present disclosure is directed to systems and methods to secure and manage home or other networks. A security management device is connected to the home network that learns about the people and devices who use the network to keep them safe and secure. The security management device determines what devices are on the network, what they are doing, and if visitors or unknown devices are attempting to gain access to the network.

The security management device provides for content filtering using, e.g., a slider, to set a maturity level such as G, PG, PG-13 and None. The security management device enforces filtering polices across all devices, websites, and apps. In some implementations, the content filter is enforced on devices, such as smartphones and other handheld devices that are used off the network outside the home. The security management device may also enforce quiet hours, where Internet access is shut-off after a certain time.

In operation, the security management device continuously scans all of the devices on the network for viruses and security risks, this includes, but is not limited IoT devices, such as smart TVs, thermostats, locks, as well as smartphones, computers and laptops. For example the device can determine if your security camera has been hacked and is connect to a suspicious website. The security management device also provides for performance monitoring, as it automatically monitors the performance of the network to detect delays or slowdowns. Because the security management device is targeted, but not limited to, home networks, an easy installation method provided. For example, a user may simple plug the device into a power outlet and follow prompting to join it the home Wi-Fi network. The security management device automatically discovers all of the other devices and learns about the network's users. After the discovery and learning, the device automatically protects the users and devices, even if they are out of the house, for example using a mobile app. The security management device interacts with a provider infrastructure to create reports and alerts that give a real-time visibility into everything that is on the network at any time.

Example Environment

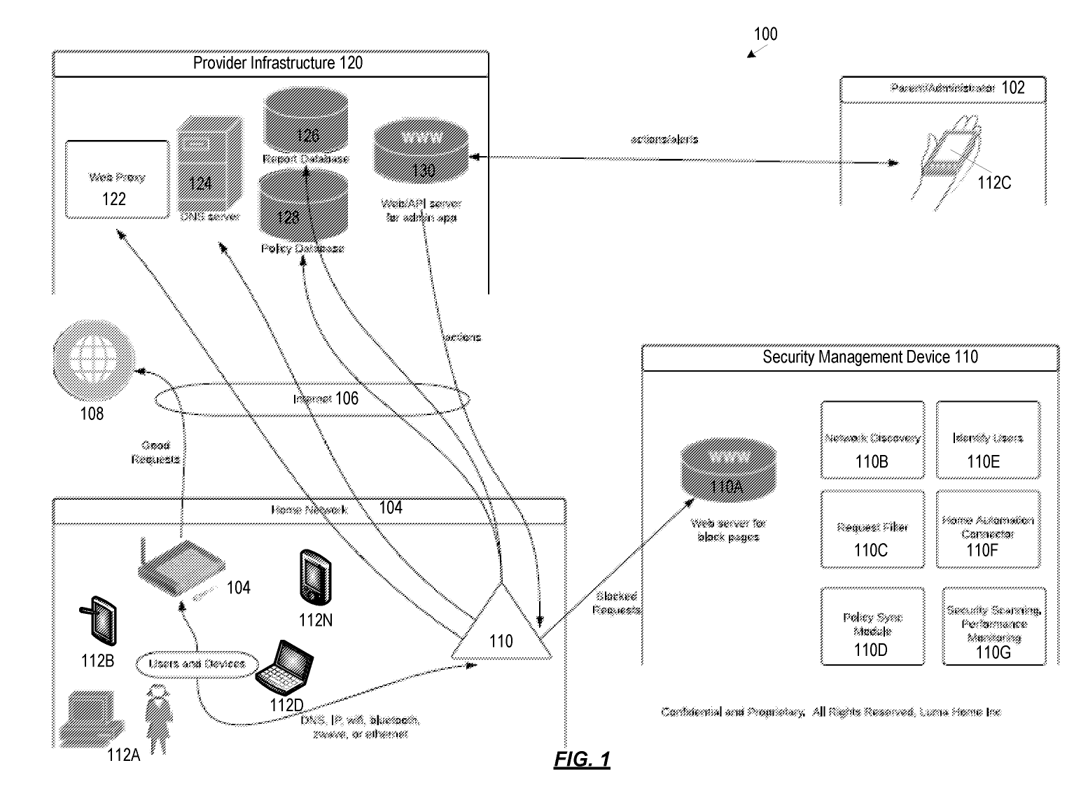

With reference to FIG. 1, there is illustrated an example environment 100 in which the present disclosure may be implemented. Within the environment 100 a home network 104 that includes a security management device 110, devices 112A, 112B . . . 112N, and a wireless access point/router 114. The devices 112A, 112B . . . 112N may be any device, such as notebook and desktop computers, hand-held gaming devices, gaming consoles, smartphones, IoT devices, and the like. The wireless access-point/router 114 may be two separate devices that respectively provide wireless access to the home network 104 and routing of communication traffic. The home network 104 may be an Internet Protocol (IP) based network, Zwave, Bluetooth, zigbee or other. The home network 104 is communicatively connected to the Internet 106 or other wide-area network infrastructure.

The security management device 110 may be provided as a self-contained enclosure having a single board, general purpose computer, such as shown in FIG. 30. The security management device 110 may include operating system, such as Linux, that provides a web server 110A for blocked pages, as described below. The security management device 110 provides services, such as network discovery 110B, request filtering 110C, policy synchronization 110D, user identification 110E, a home automation connector 110F, and security scanning and performance monitoring 110G.

The web server 110A may host landing pages for blocked pages, as described below. The landing pages may show a reason for the blocking, such as security, inappropriate content, etc. The landing page may include a code that is retrieved from the web server 130 to indicated to a user that he/she should wait for an allow or override from the administrator 102. It an override is allowed, the page refreshes and sends the user to the originally requested page. An option may be provided to bypass the blocked page using, e.g., a username and password, or on a per-device basis. Custom blocked pages may be provided. A one-click operation may be provided to block all Internet usage.

The network discovery module 110B identifies devices on the network 104 including, but not limited to, a device type and a device owner, such as “ipad, paul”, “macbook air, john.” For example, Address Resolution Protocol (ARP) may be used to identify the devices 112A, 112B . . . 112N. Protocols such as NetBios, SAMBA, etc. may be used to identify network names. A device scan may be used identify device types.

The request filter 110C may be operated as DNS web filter. Based on a requested IP address and MAC address of the requesting device, an appropriate policy is queried from the policy synchronization module 110D and applied to the DNS query. This may include performing a user lookup to see which user is currently requesting an IP address. The policy retrieved from the policy synchronization module 110D determines if the response to the DNS query should be the “real” response (i.e., the IP address of the requested site) or a policy-based response (a blocked page served by the web server 110A). For a real response, the response may be retrieved from a lookup in a local cache of the security management device 110 or query response returned from the DNS server 124. For a policy-based response, the IP address of an appropriate block page is returned (e.g., the IP address of the web server 110A). Pages may be blocked for reasons, such as, security, inappropriate content etc.

The policy sync module 110D synchronizes with the policy database 128 to locally cache policies on the security management device 110. As noted above, the policy sync module 110D may be called by the request filter 110C to determine an appropriate response to a DNS query in accordance with a requesting device, user and/or combination thereof.

The device and user identification module 110E may use a device's media access control (MAC) address as a device ID, as the MAC address is unique to each device. For shared devices, an optional user log-in may be used to apply a policy. Information regarding the wireless access point/router 114 may be retrieved using Simple Network Management Protocol (SNMP). Device and user presence may be tracked.

The home automation connector module 110F provided to support specific systems, such as WINK, AT&T home automation, Xfinity, SmartThings, etc. Other systems may be supported by adding the appropriate logic to the home automation connector module 110F. Put allowed: [action, time]; action: (Block all, Block all kids, Allow all), time in minutes. GET actions allowed: get reading. The home automation connector module 110F provides for a takeover displays action, where input from home automation systems is displayed on all computer and device screens. For example, if a smoke detector alarms, a notification may be provided in a user interface of the devices 112A, 112B . . . 112N, as described below.

A provider infrastructure 120 includes a web proxy 122, a DNS server 124, a reports database 126, a policy database 128 and a Web/API server 130. The provider infrastructure may be located anywhere, such as on a public or private cloud, or remote server. The web proxy 122 provides for content inspection and operates as a transparent proxy. For example, websites that require deeper inspection are redirected by the DNS server 124 to the web proxy 122. The DNS server 124 is used by devices 112A, 112B . . . 112N for lookups. The reporting database 126 includes information, such as usage statistics and alerts. The information may be used to generate reports. The policy database 128 may include a multitenant schema that is organized by homes, accounts, devices, users and policies. The policies define characteristics, such as website categories, devices allowed, timestamps, users, apps, total time on site, security threats known, and blocked pages. The Web/API server 130 is accessed by an administrator 102 using a device (e.g., 112C) that may on or off the home network 104. The Web/API server 130 provides access to reports and other information, as described below.

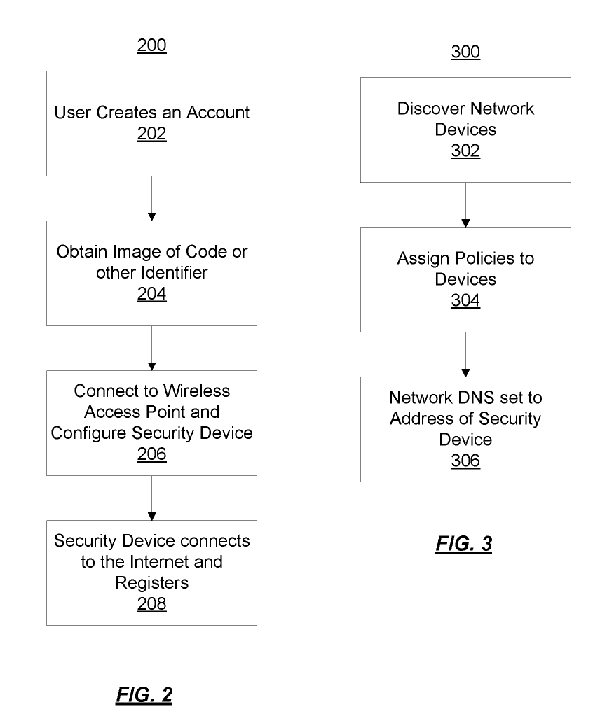

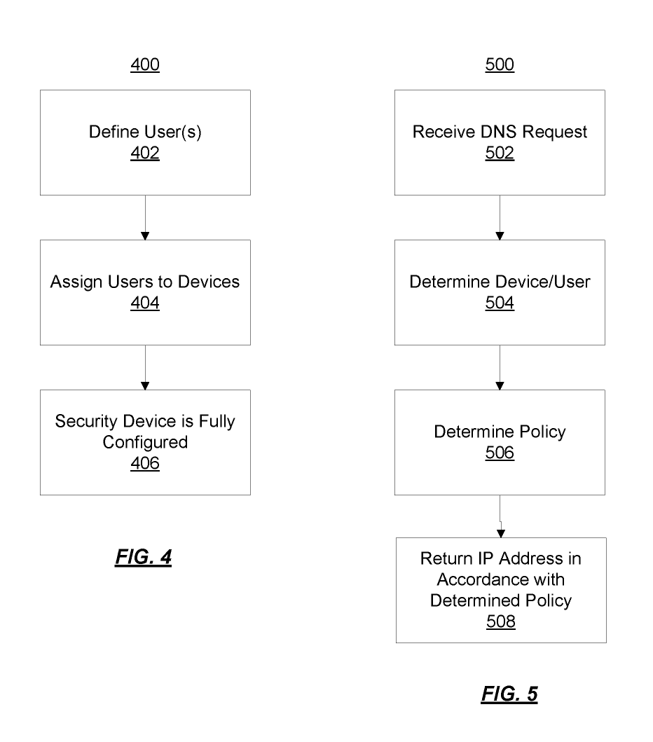

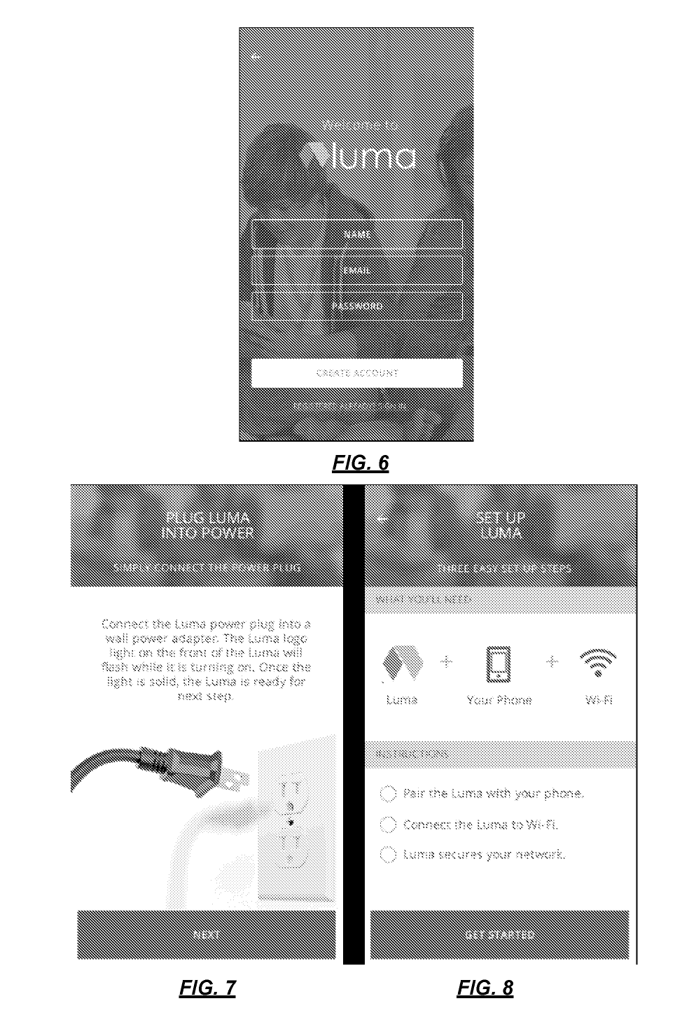

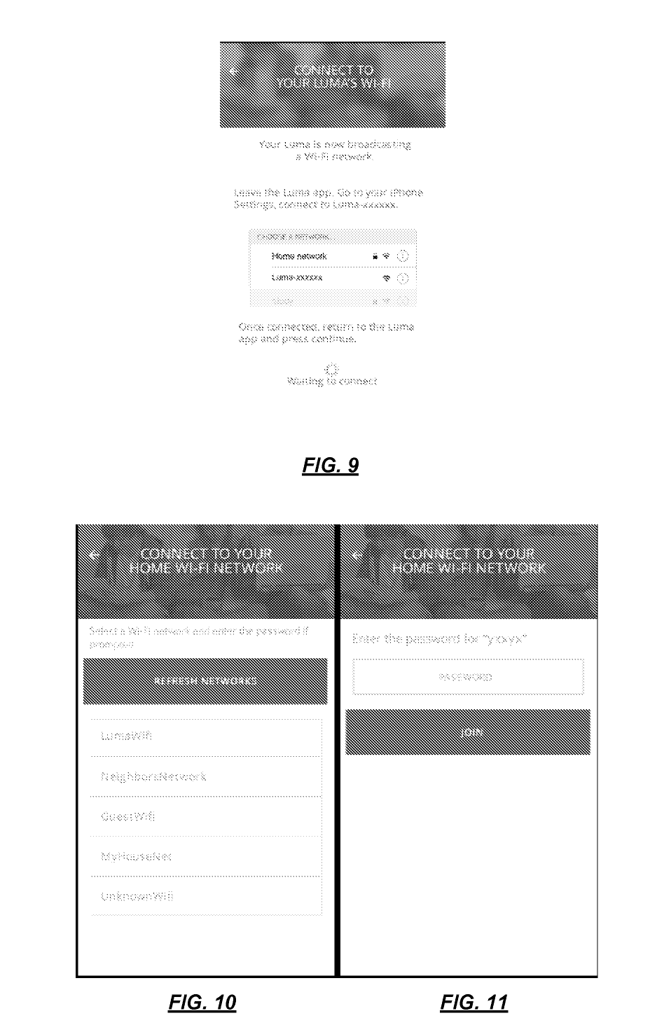

With reference to FIGS. 2 and 6-11, there is illustrated an example operational flow 200 for configuring the security management device 110 for use on the home network 104, together with associated user interfaces. A mobile app, as shown in FIGS. 6-11 may be provided to setup the security management device 110 using smartphones, such as IPHONE and ANDROID (and other) devices to associate the security management device 110 with a user account and the home network 104. At 202, through the mobile app, a user may be prompted to create an account on the provider infrastructure 120 (see, FIG. 6). The user may be instructed to plug the security management device 110 into a power outlet (see, FIG. 7) and prompted with steps to be performed to configure the security management device 110 (see, FIG. 8). Once created, at 204, a user may take a picture of a QR code (or other) on the security management device 110. At 206, the mobile app will connect to the wireless access point/router 114 and configure the security management device 110 to connect to the wireless access point/router 114 (see, FIGS. 9-11). At 208, the security management device 110 connects to the Internet 106 and registers with the with provider infrastructure 120 using the user account and QR code.

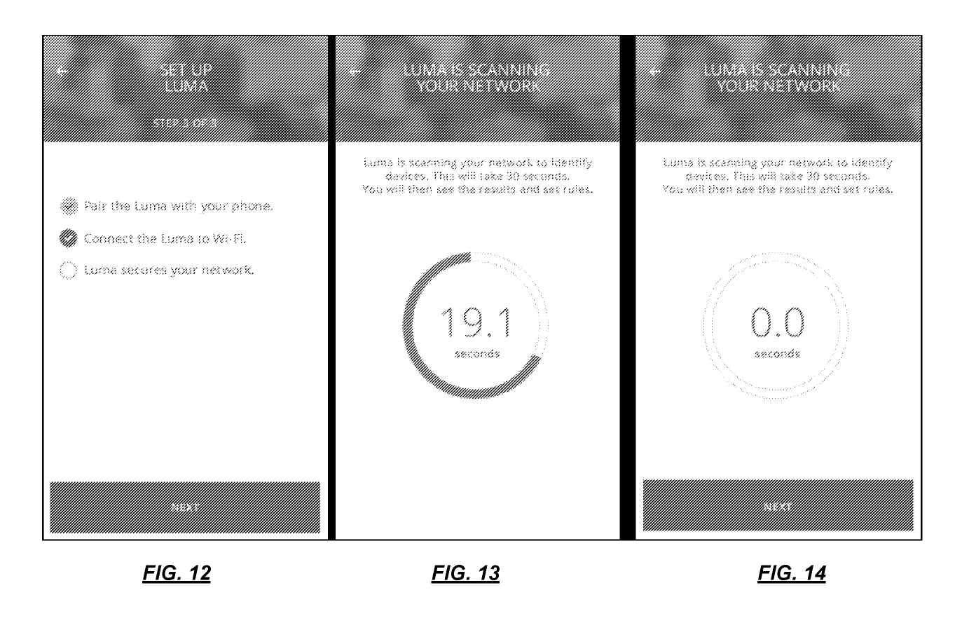

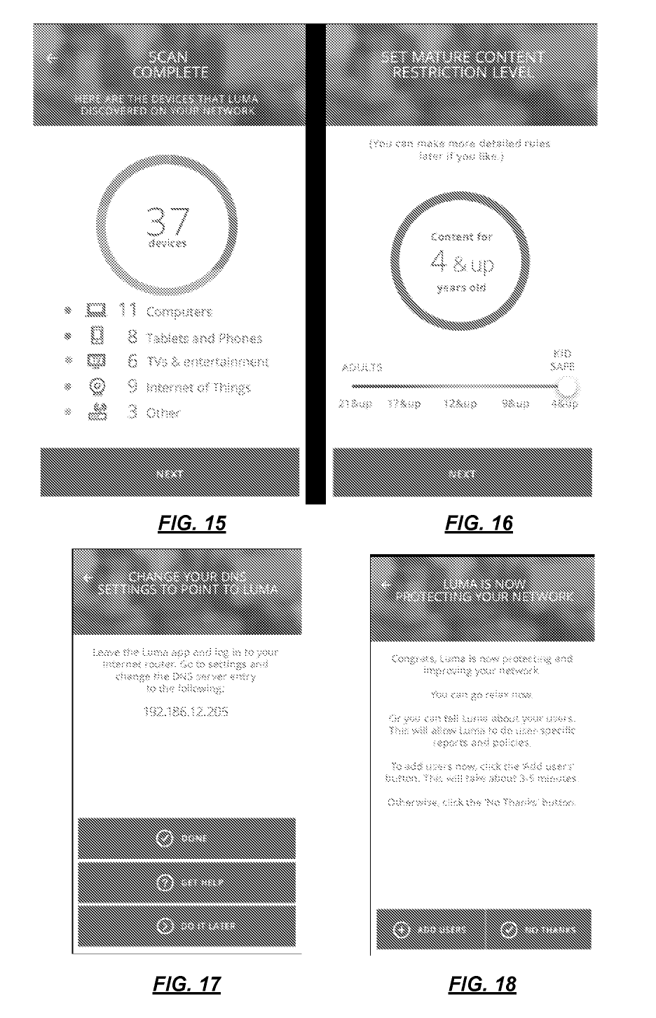

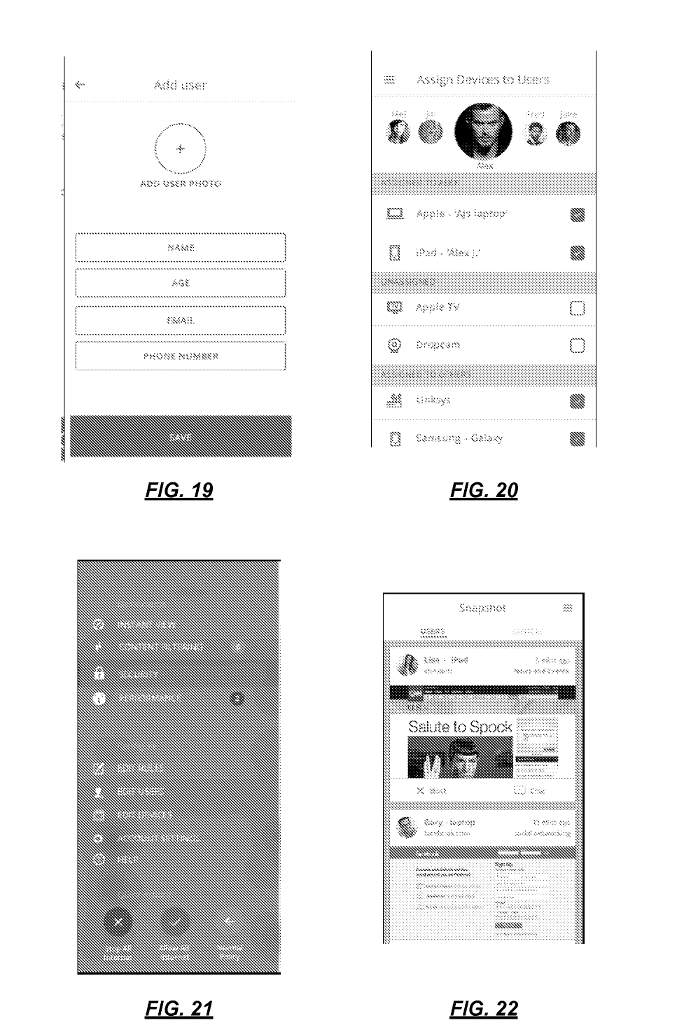

Once registered, With reference to FIGS. 3 (operational flow 300) and 12-18, the security management device 110, at 302, discovers devices 112A, 112B . . . 112N on the home network 104 using the network discovery module 110A (see, FIGS. 12-15). A progress bar maybe shown in the app while the network discovery module 110A is running. When devices are identified, the user may be provided an option to name devices that are unnamed. After initial discovery, when a new or unnamed device on the home network 104 tries to visit any web page, the new or unnamed device receives a screen to input a name, this screen may be provided by the web server 110A of the security management device 110. Next, at 304, policies are assigned to the devices 112A, 112B . . . 112N. For example, a user may be asked to assign each discovered device 112A, 112B . . . 112N to a policy. Default policies may be provided based on age, such G, PG, PG-13, R, Adult, similar to movie ratings (see, FIG. 16). At 306, the user then sets the DNS address of the router 114 to the IP address of the security management device 110 (see, FIG. 17). The security management device 110, is now ready to monitor the home network 104 and devices 112A, 112B . . . 112N (see, FIG. 18).

The security management device 110 can interact with the home network 104 in various manners. As described above, the security management device 110 may become a DNS server for the home network 104. In this configuration, each time one of devices 112A, 112B . . . 112N requests a DNS lookup, the request is serviced by the security management device 110. In accordance with the policy applied to a particular device 112A, 112B . . . 112N, the security management device 110 may return the “real” response (i.e., the IP address of the requested site) or a policy-based response (a blocked page served by the web server 110A). For a real response, the response may be retrieved from a lookup in a local cache of the security management device 110 or query response returned from the DNS server 124. For a policy-based response, the IP address of an appropriate block page is returned (e.g., the IP address of the web server 110A).

The security management device 110 may become a Wi-Fi access point. The security management device 110 may perform this by acting as a range extender or by replacing the existing Wi-Fi access point (e.g., wireless access functions of the wireless access point/router 114). The security management device 110 may be attached directly to a router (e.g., routing functions of the wireless access point/router 114) and operate out-of-band. When in this mode, the security management device 110 analyzes communication traffic and then performs remediation actions, such as connection resets. The security management device 110 may be deployed in inline and act as the router or switch. In accordance with the present disclosure, the security management device 110 may be deployed in any combination of the above. For example, the security management device 110 may be configured as the DNS server, and additional security management devices 110 may be added as Wi-Fi access points. In another example, when the security management device 110 operates as the Wi-Fi access point, it may be configured with additional filtering and blocking capabilities.

Referring now to FIGS. 4 and 19-20, there is illustrated an operation flow 400 to associate users to devices. At 402, users are added (see, FIG. 19). Information regarding each user, such as name, age, email address, phone number, etc., may be collected. At 404, users are assigned to known devices (see, FIG. 20). At 406, the security management device 110 is now fully configured and ready to protect and monitor the home network 104.

FIG. 5 illustrates an example operational flow 500 of the security management device 110 operating as a DNS server for the home network 104. At 502, the security management device 110 receives a DNS lookup request. This may be handled by the request filter module 110C. At 504, the security management device determines the identity of the device and/or user making the request at 502. At 506, a policy to be applied to the request determined. The policy sync module 110D or the policy database 128 may be access to determine how the request filter 110C should respond to the DNS request. At 508, the security management device 110 returns are response to the DNS request to the requesting device 112A, 1126 . . . 112N. In accordance with the policy applied to the requesting device 112A, 1126 . . . 112N, the security management device 110 may return the “real” response or the policy-based response, as described above.

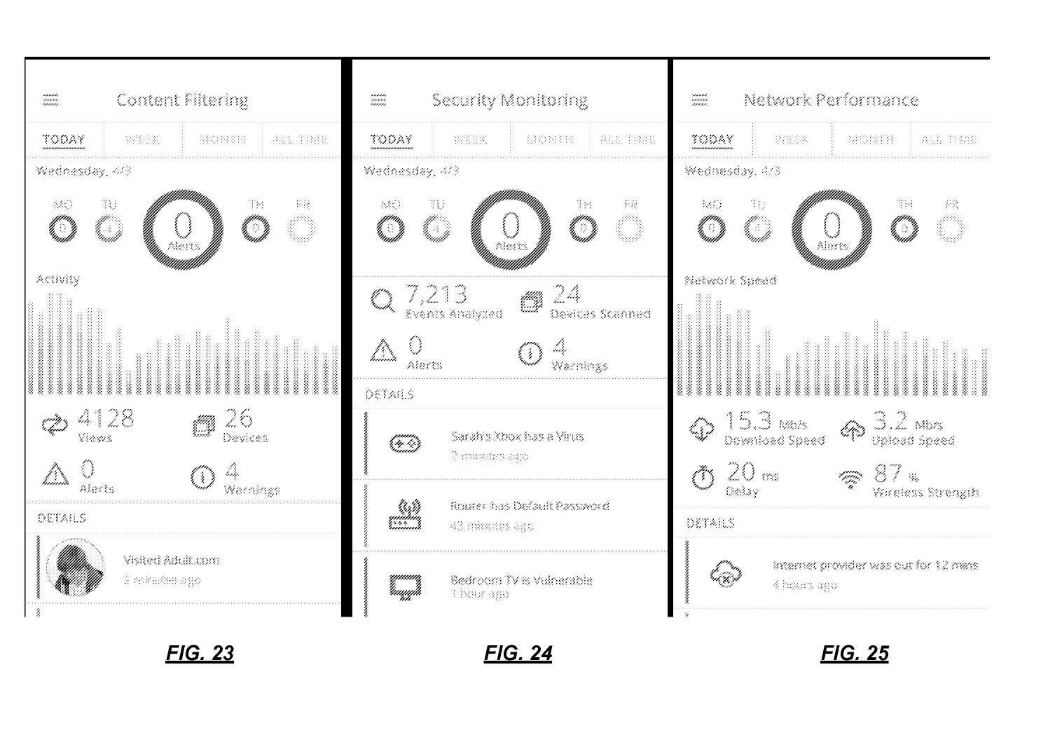

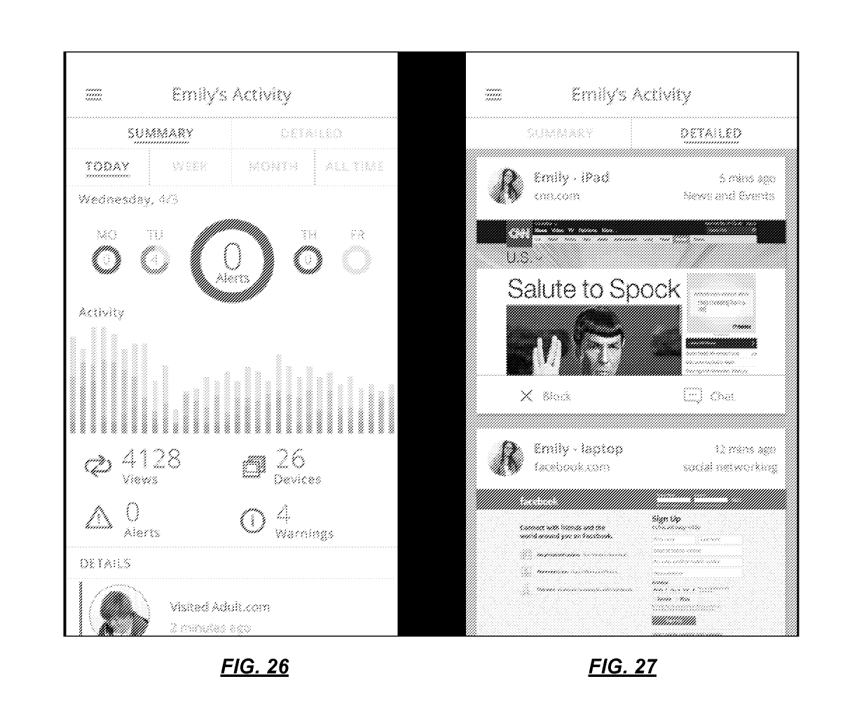

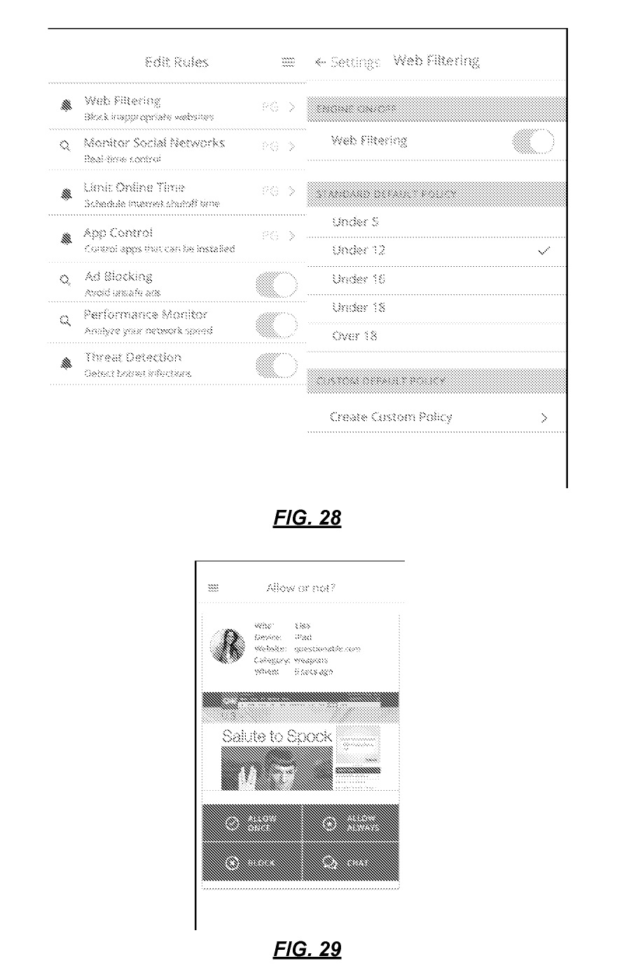

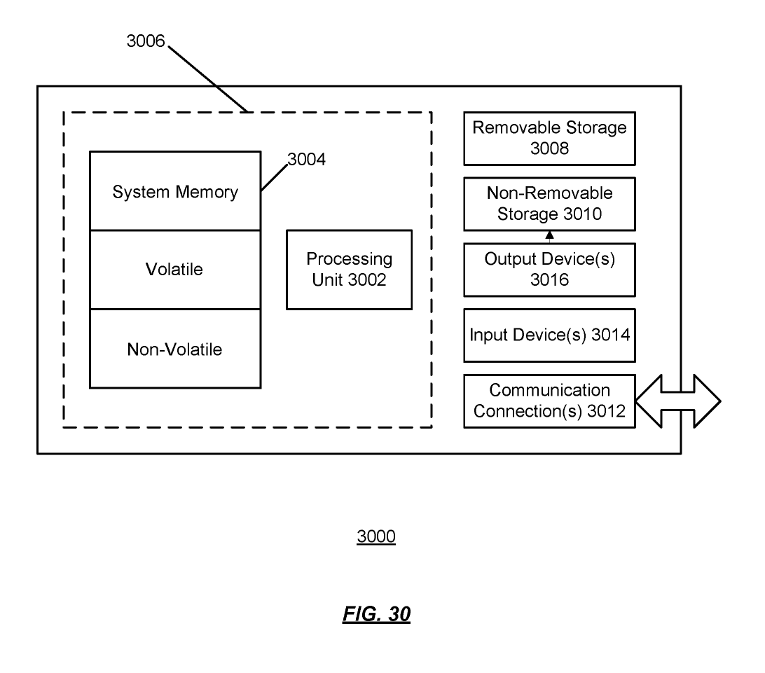

The provider infrastructure 120 provides reports to the administrator 102, in the form of dashboards, snapshots of user's website visits or other usable interfaces, as shown in FIGS. 21 and 22. The reports may include information on websites visited (e.g., on per/user basis), bandwidth, apps. As shown in FIGS. 23-25, the reports may show statistics related to content filtering, security monitoring and network performance. The reports may be focused on a specific user's activity, such as shown in FIGS. 26-27. The administrator 102 may be provided an option on the app to edit polices (see, FIG. 28).

As shown in FIG. 29, the administrator 102 may be provided alerts and override request. For example, if a user attempts to access a questionable website, the administrator may be provided with a user interface to allow once, allow always, block, and/or chat with the user. The administrator 102 maybe provided a screenshot of requested page on the device 112C.

The provider infrastructure 120 may provide a hyper-lapse video or collage of what a user viewed on his/her device 112A, 112B . . . 112N.

Other features include alerting based on usage during quiet times. For example, a child may be accessing the Internet at 10:00 PM. Another type of alert provided when a new device is discovered trying to access the home network 104.

Yet other features of the security management device 110 and provider infrastructure 120 are as follows:

Mobile Device Management

The system of the present disclosure may also include endpoint agents that execute on mobile devices and computers on the home network 104. For mobile devices, this can be achieved by using Apple and Android Mobile Device Management (MDM) capabilities. For example, the administrator 102 may require that every device on the wireless home network 104 install an endpoint agent. The endpoint agent may provide for additional filtering and blocking capability. The endpoint agent may also provide enforcement when the device is out of the home and on different networks.

IoT Security

The security management device 110 can create whitelist based policies that only allow certain IoT devices to connect to allowed sites. For example, a Nest thermostat should only be able to connect to the Nest website and not to network-aware appliances. The security management device 110 can create these policies using a combination of pre-defined rules from the policy database 128, as well as learning behaviors and performing anomaly detection.

The security management device 110 provides for home user vulnerability scanning. Traditional enterprise vulnerability scanning provides low level results that are not be actionable for a home user. The security management device 110 provides for vulnerability scanning, but produces results and action recommendations that are appropriate for a home user.

User-Based Policies

The security management device 110 maps devices to users and allows user-based policies that apply to all devices that a user utilizes. In some implementations, the security management device 110 does this without software running on the users' devices, as it uses DNS. Polices can control usage by time of day, by user, by device.

Rating Based Policies

The security management device 110 may use user interface element, such as a simple slider to define policy based on age rating such as “under 14” or “under 12” or PG or G. The security management device 110 may map the slider selection to an aged-based policy, which applies rules for websites, apps, and content and apply for the user across all devices.

Home Network Performance Management.

The security management device 110 monitors the home 104 network for performance and outages. If any problems are detected, the security management device 110 notifies the user. The security management device 110 may suggest an action to fix the issues. In some cases, the security management device 110 can automatically fix problems. For example, it can block network access for a device that is misbehaving or interfering with other uses.

The security management device 110 can selectively disable Internet access for non-essential devices (e.g., everything but appliances like Canary or Dropcam) to conserve bandwidth (e.g., at bedtime). Doing so saves money by preventing ISP overages, but in a way that still keeps the home safe (versus, say, unplugging the router each night). The security management device 110 can block software updates such that they happen only at night or at least not during the middle of a streaming movie.

Instant View

This functionality allows the administrator 102 to instantly see what every device on your network is doing in a graphical format representing the screen of the user. It is like having a dropcam for your network.

Actionable Internet Alert

The security management device 110 may send alerts when suspicious activity is noticed. The administrator can control the outcome or action with a click of the button in the app. For example, if a child goes to a questionable site, the security management device 110 sends an alert to the administrator 102 in the app (e.g., executing on device 112C) and the administrator 102 can decide whether to allow, block or chat with the child. When the administrator 102 presses the button in the app, security management device 110 blocks or allows the activity. The app also allows an instant Internet off button to turn off all internet activity instantly.

Screen Takeover Chat

The administrator 102 is provided with an action to “chat now” with a user regardless of what device they are using. This allows the administrator 102 to take over the screen of the child's device (tablet, phone, computer, TV, etc.) and force a chat session. This may be implemented using DNS redirection to send a page provided by the web server 110A to the user's device. The chat can be text, audio or video. This chat action can be invokes as a result of a policy violation, or it can be prompted by the administrator 102 at any time.

Screen Takeover Alerts

In addition to taking over screens for chat, security management device 110 can take over select or all screens (tablet, phone, computer, TV, etc.) to provide alerts such as bedtime, smoke alarm or dinner time. The security management device 110 can receive triggers from other systems like home automation systems and then deliver those alerts to select screens or all screens. This may be implemented using DNS redirection to redirect any Internet access by a device to a page provided by the web server 110A.

Time Enforcements

The security management device 110 can enforce bedtime or homework time. Bedtime, for example, means no Internet access. Homework time means that Internet access is limited to productive sites instead of entertainment sites.

Example Computing Environment

FIG. 30 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 30, an exemplary system for implementing aspects described herein includes a computing device, such as computing device 3000. In its most basic configuration, computing device 3000 typically includes at least one processing unit 3002 and memory 3004. Depending on the exact configuration and type of computing device, memory 3004 may be volatile (such as random access memory (RAM)), non-volatile (such as read-only memory (ROM), flash memory, etc.), or some combination of the two. This most basic configuration is illustrated in FIG. 30 by dashed line 3006.

Computing device 3000 may have additional features/functionality. For example, computing device 3000 may include additional storage (removable and/or non-removable) including, but not limited to, magnetic or optical disks or tape. Such additional storage is illustrated in FIG. 30 by removable storage 3008 and non-removable storage 3010.

Computing device 3000 typically includes a variety of tangible computer readable media. Computer readable media can be any available tangible media that can be accessed by device 3000 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 3004, removable storage 3008, and non-removable storage 3010 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 3000. Any such computer storage media may be part of computing device 3000.

Computing device 3000 may contain communications connection(s) 3012 that allow the device to communicate with other devices. Computing device 3000 may also have input device(s) 3014 such as a keyboard, mouse, pen, voice input device, touch input device, etc. Output device(s) 3016 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for managing network access, comprising:
receiving a Domain Name Service (DNS) request from a device on a network, the device being associated with a user and the request being in the form of a Uniform Resource Locator (URL);
determining an identity of the device or user making the DNS request;
retrieving a policy associated with the device or user;
applying the policy to the DNS request; and
returning a response to the DNS request that is either an IP address associated with the URL or an IP address of a block page that is defined by the policy.

2. The method of claim 1, wherein the policy is defined as an age-based policy set in accordance with a maturity level of a user associated with the device.

3. The method of claim 2, further comprising:
providing an administrative user interface at a second device associated with an administrator;
presenting a slider graphical element in the administrative user interface to define the age-based policy; and
setting the age-based policy in accordance with actuation of the slider graphical element.

4. The method of claim 3, wherein the slider graphical element defines the age-based policy in accordance with predetermined age ranges.

5. The method of claim 1, wherein the policy is a time-of-day policy, and wherein network access to the device is shut-off after a predetermined time.

6. The method of claim 1, further comprising:
automatically discovering the devices on the network; and
associating a user with each device discovered on the network.

7. The method of claim 1, further comprising monitoring mobile devices using a mobile app the sends the DNS request.

8. The method of claim 1, further comprising:
providing, to a second device associated with an administrator, a view of a user interface being displayed at the device; and
providing an option to the administrator to override the response to the DNS request or to chat with the user of the device.

9. A security management device, comprising:
a memory that stores computer executable instructions;
a network interface that connects the security management device to a home network; and
a processor that executes the computer executable instructions to provide a network discovery module, a request filtering module, a policy synchronization module, and a user identification module,
wherein the security management device receives at the request filtering module a Domain Name Service (DNS) request associated with a Uniform Resource Locator (URL) from a device on a network, wherein the security management device retrieves a policy associated with a user of the device from the policy synchronization module, and wherein the security management device returns a response to the DNS request that is either an IP address associated with the URL or an IP address of a block page that is defined by the policy.

10. The security management device of claim 9, wherein the network discovery module identifies devices on the network, and wherein the user identification module receives an indication of a user to be associated with the device.

11. The security management device of claim 9, wherein the policy synchronization module synchronizes with a remote policy database to locally cache policies on the security management device.

12. The security management device of claim 9, wherein the security management device is a Wi-Fi access point.

13. The security management device of claim 9, wherein the security management device provides a chat functionality between an administrator associated with a second device and a user associated with the device to enable the administrator to take over the screen of the device and force a chat session between the administrator and the user.

14. The security management device of claim 9, wherein an administrator associated with a second device is provided with a view of a user interface being displayed at the device and to enable the administrator to override the policy.

15. An apparatus for providing network security and management, comprising:
a security management device that includes a memory that stores computer executable instructions, a network interface to connect to a home network, and a processor that executes the instructions to discover devices on the home network, associated users with devices on the home network, apply at least one policy to each user or device on the home network, and selectively provide access to network resourced in accordance with the at least one policy; and
a provider computing infrastructure that includes a web proxy, a DNS server, a reports database, a policy database, and a Web/API server.

16. The apparatus of claim 15, wherein the security management device receives a Domain Name Service (DNS) request associated with a Uniform Resource Locator (URL) from a device on a network, and wherein the security management device returns a response to the DNS request that is either an IP address associated with the URL or an IP address of a block page that is defined by the at least one policy.

17. The apparatus of claim 15, wherein the web proxy performs content inspection of a website associated with the URL.

18. The apparatus of claim 15, wherein the policy database includes policies that define website categories, devices allowed, timestamps, users, apps, total time on site, security threats known, and blocked pages.

19. The apparatus of claim 15, wherein the at least one policy us provided as a ratings-based policy based on an age of a user associated with a particular device.

20. The apparatus of claim 14, wherein an administrator is provided with a view of a user interface of a device on the home network in a graphical format representing the screen of the device.

21. The apparatus of claim 20, wherein the administrator is provided a snapshot of a webpage associated with the request and with an option to allow to allow once, allow always, block, and/or chat with the user.

22. The apparatus of claim 15, further comprising an endpoint agent that executes on each of the devices to enforce the at least one policy associated with the device.
